(19) United States
(12) Patent Application Publication
(10) Pub. No.: US 2017/0019929 A1
(43) Pub. Date: Jan. 19, 2017

(54) Method, Device and System for Detecting Random Access Signal in Interference Environment

(71) Applicant: ZTE CORPORATION, Shenzhen City, Guangdong Province (CN)

(72) Inventors: Wenfang WANG, Shenzhen (CN); Shaopeng WANG, Shenzhen (CN); Hongfeng QIN, Shenzhen (CN)

(73) Assignee: ZTE CORPORATION, Shenzen City, Guangdong Province (CN)

(21) Appl. No.: 15/123,682

(22) PCT Filed: Aug. 22, 2014
(86) PCT No.: PCT/CN2014/085073

§ 371 Date: Sep. 6, 2016

(30) Foreign Application Priority Data
Mar. 12, 2014 (CN) 201410091391.2

(51) Int. Cl. H04W 74/08; H04B 1/10

(52) U.S. Cl. CPC H04W 74/0833; H04B 1/1027

(57) ABSTRACT

A method, device and system for detecting a random access signal in an interference environment. The method includes: receiving a time-domain random access signal to obtain a frequency-domain random access signal; obtaining interference cancelling weights according to the frequency-domain random access signal and a frequency-domain local cyclic shift sequence, and performing interference cancelling on the frequency-domain random access signal with obtained interference cancelling weight; and performing peak detection on the frequency-domain random access signal after interference cancelling. The device includes an obtaining module configured to receive a time-domain random access signal to obtain a frequency-domain random access signal; an interference cancellation module configured to calculate interference cancelling weights according to the frequency-domain random access signal and a frequency-domain local cyclic shift sequence, and perform interference cancelling on the frequency-domain random access signal; and a detection module configured to perform peak detection on the frequency-domain random access signal after interference cancelling.

### TECHNICAL FIELD

The present document relates to the field of mobile communication technology, and in particular, to a method, device and system for detecting a random access signal in an interference environment.

### BACKGROUND OF THE RELATED ART

In the Long Term Evolution (LTE) system, the mobile terminal first performs downlink synchronization through a synchronization Channel (SCH) to determine a radio frame, initial position for receiving the sub-frame, and cell ID after being started up; and then obtains system information by detecting a Broadcast Channel (BCH), wherein the system information includes the configuration information of the Random Access Channel (RACH); and finally performs uplink synchronization through the random access signal transmitted through the RACH to complete the procedure of accessing the system.

In the procedure of performing uplink synchronization, the mobile terminal first finds the position of the RACH based on the radio frame and sub-frame determined in downlink synchronization, and determines the initial position for sending a uplink random access preamble, and then sends one sequence selected randomly from the available sequences as a uplink random access preamble of a random access signal. A base station detects the uplink random access preamble to determine a timing adjustment quantity for uplink synchronization, which is sent to the mobile terminal by the base station, and the mobile terminal adjusts the moment for sending a uplink signal to achieve the time synchronization of the uplink channel.

The uplink random access preamble of the LTE system is generated by one or more Zadoff-Chu (ZC) root sequence. A u^{th} ZC root sequence is defined as

$${x}_{u} ( n ) = {e}^{- j \frac{π un ( n + 1 )}{{N}_{ZC}} ,}$$

0≦n≦N_{ZC}−1. Wherein, the length of the ZC root sequence N_{ZC} in the mode of format 0˜3 is 839, and the length is 139 in the mode of format 4. There are 64 sequences for generating the uplink random access preamble in each cell, and the 64 sequences may be various cyclic shift sequences from the same root sequence, may also be cyclic shift sequences from different root sequences. The ZC root sequence is Constant Amplitude zero Auto-correlation Code (CAZAC in short), whose correlation has the following features: the correlation between the various cyclic sequences in the same root sequence is 0; the correlation between various root sequences (including their mutual cyclic shift sequences) is 1/\sqrt{N_{2C}}, i.e. the correlation between the uplink random access preamble of the random access signal and the sequence which does not generate the random access preamble is so low that the correlation may be taken to be approximately equal to zero, and the correlation between the uplink random access preamble of the random access signal and the sequence which generates the uplink random access preamble is highest. Therefore, the random access preamble sent by the terminal may be determined in the method that random access signal is detected in time-domain with the correlation between uplink random access preamble of the random access signal and all of the sequences, to obtain an uplink timing adjustment quantity to achieve the time synchronization of the uplink channel.

In a related method for detecting a random access signal, when there is a higher interference of the adjacent cell, the peak of the signal may be drowned out by the interference and noise which will lead to signal miss detection; meanwhile, due to the influence of the interference, false peak may be detected which will result in false detection. In addition, when there are a higher power signal and a lower power signal in the cell concurrently, for the lower signal, the higher signal is the interference in the cell that increases the possibility of lower signal miss detection. In some methods for serially cancelling interference in existing art, a reconstructed interference signal is subtracted from a received random access signal before detecting, whenever a useful signal is detected, the reconstructed useful signal is subtracted from the received random access signal, and the detection is continued. This method firstly requires the interference signal is known, which has a higher requirement on the system; secondly, a plurality of reconstructions are required, more resources will be occupied, the calculation is large, so that the method is difficult to realize and apply.

In conclusion, the related art has at least the following deficiencies: the method for detecting a random access signal doesn't take account of the influence of interference, and has a problem that the index of missing detection and false detection is higher in the environment of adjacent cell interference signal, which has a higher requirement on the system, and occupies more resources, so that the method is difficult to realize and apply.

### SUMMARY

In view of the above, the present document discloses a method, device, and system for detecting a random access signal in an interference environment, which cancel the deterioration of the miss detection performance and false alarm performance caused by the interference.

In one aspect, the present document discloses a method for detecting a random access signal in an interference environment, and the method includes:
receiving a time-domain random access signal to obtain a frequency-domain random access signal;
obtaining interference cancelling weights respectively according to the frequency-domain random access signal and a frequency-domain local cyclic shift sequence, and performing interference cancelling on the frequency-domain random access signal with the obtained interference cancelling weight; and
performing peak detection on the frequency-domain random access signal on which interference cancelling has been performed.

In another aspect, the present document discloses a device for detecting a random access signal in an interference environment, and the device includes:
an obtaining module configured to receive a time-domain random access signal to obtain a frequency-domain random access signal;
an interference cancellation module configured to obtain interference cancelling weights according to the frequency-domain random access signal and a frequency-domain local cyclic shift sequence, and perform interference cancelling on the frequency-domain random access signal according to the obtained interference cancelling weight; and
a detection module configured to perform peak detection on the frequency-domain random access signal on which interference cancelling has been performed.

The method, device and system for detecting a random access signal in an interference environment disclosed in the embodiments of the present document are used to receive a time-domain random access signal to obtain a frequency-domain random access signal; perform interference cancelling on the frequency-domain random access signal according to the frequency-domain random access signal and a frequency-domain local cyclic shift sequence; and perform peak detection on the frequency-domain random access signal on which interference cancelling has been performed. The method, device and system for detecting a random access signal in the interference environment disclosed in the embodiments of the present document may cancel the deterioration of the miss detection performance and false alarm performance caused by the interference while the random access signal is detected, improve the accuracy of detection, and save resources.

### BRIEF DESCRIPTION OF DRAWINGS

FIG. 1 is a diagram of a flow chart of a method for detecting a random access signal in an interference environment according to an embodiment of the present document;

FIG. 2 is a diagram of a flow chart of a detection method for performing firstly power combination on the peak detection sequences with the repetition format according to an embodiment of the present document;

FIG. 3 is a diagram of a flow chart of a detection method for determining the sequence validities of all the frequency-domain cyclic shift sequences according to an embodiment of the present document;

FIG. 4 is a diagram of a flow chart of a detection method for performing group selection and group combination on all the frequency-domain cyclic shift sequences according to an embodiment of the present document;

FIG. 5 is a diagram of a device for detecting a random access signal in an interference environment according to an embodiment of the present document;

FIG. 6 is a diagram of a structure of a detection device when down-sampling is performed according to an embodiment of the present document;

FIG. 7 is a diagram of a detection device for performing firstly power combination on the peak detection sequences with the repetition format according to an embodiment of the present document;

FIG. 8 is a diagram of a detection device for determining the sequence validities of all the frequency-domain cyclic shift sequences according to an embodiment of the present document;

FIG. 9 is a diagram of a detection device for performing group selection and group combination on all the frequency-domain cyclic shift sequences according to an embodiment of the present document; and

FIG. 10 is a schematic diagram of a structure of a system for detecting a random access signal in an interference environment according to an embodiment of the present document.

### PREFERRED EMBODIMENTS

The main implementation principle, specific embodiment and beneficial effects thereof which can be achieved of the technical scheme disclosed in the present document will be described in detail in combination with the accompanying drawings below.

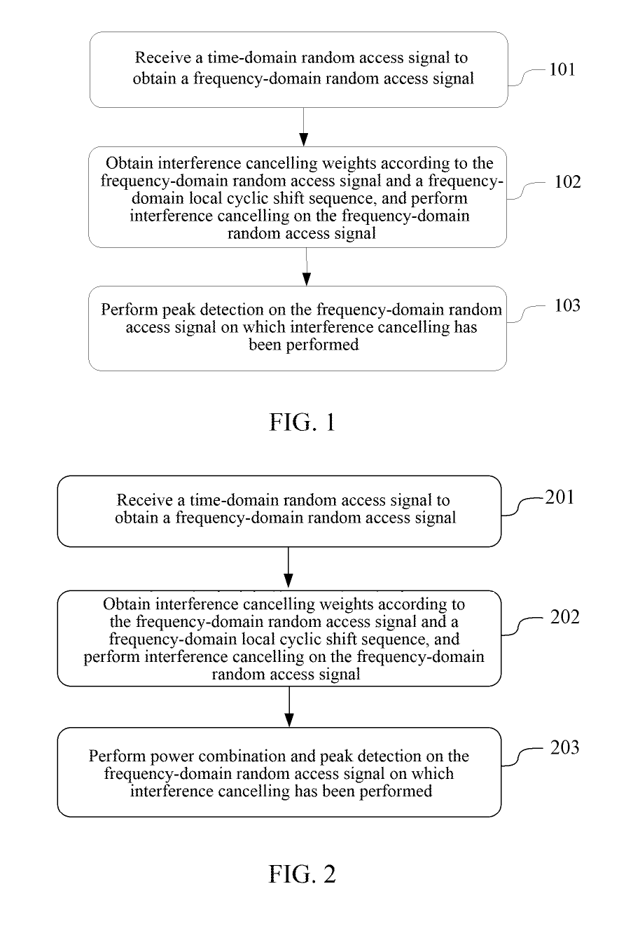

The embodiment 1 as shown in FIG. 1 is a method for detecting a random access signal in an interference environment, which is provided by the present document, and the method includes the following steps:
in step 101, a base station receives a time-domain random access signal to obtain a frequency-domain random access signal.

The base station receives the time-domain random access signal, then converts the time-domain random access signal to the frequency-domain random access signal. The specific procedure for forming the frequency-domain random access signal may include: the base station converts the received time-domain random access signal from time-domain to frequency-domain by Fast Fourier Transform processing. Of course, the down-sampling may also be performed on the received random access signal first before the FFT.

In step 102, the base station obtains interference cancelling weights according to the frequency-domain random access signal and a frequency-domain local circular shift sequence, and performs interference cancelling on the frequency-domain random access signal with the obtained interference cancelling weight.

The specific procedure of this step may include: the interference cancelling weight is obtained respectively according to the frequency-domain random access signal and the frequency-domain local cyclic shift sequence, and then weighted combination is performed on the frequency-domain random access signal according to the interference cancelling weight, thus the frequency-domain random access signal on which interference cancelling has been performed is obtained.

Let M be the number of receiving antennas; and let N be the number of sub-carrier waves, for the long RACH, N=839, the number of dimensions of S is 1×N, the number of dimensions of Y is M×N, and the number of dimensions of Ŷ is 1×N.

A method for calculating the interference cancelling weight is:

W=R_{SY}R_{YY}⁻¹ (1)

wherein, W represents an interference cancelling weight, S represents a frequency-domain local cyclic shift sequence, Y represents a frequency-domain random access signal before interference cancelling is performed, R_{SY}=E{SY^{H}}, R_{YY}=E{YY^{H}}, R_{SY} represents a cross-correlation covariance matrix of the frequency-domain random access signal and frequency-domain local cyclic shift sequence, and R_{YY} represents an auto-correlation covariance matrix of the frequency-domain random access signal;
a method for performing weighted combination on the frequency-domain random access signal according to the interference cancelling weight is:

Ŷ=WY (2)
wherein, Ŷ represents a frequency-domain random access signal on which interference cancelling has been performed, W represents an interference cancelling weight, Y represents a frequency-domain random access signal before interference cancelling is performed.

In step 103, the base station performs peak detection on the frequency-domain random access signal on which interference cancelling has been performed.

Wherein, the specific procedure of peak detection may include: the frequency-domain random access signal is conjugation dot multiplied by the frequency-domain local root sequence or the frequency-domain local cyclic shift sequence, a formula for conjugation dot multiplying is represented as Ŷᵢ*Sᵢ^{H}, wherein, i represents an index number of an element of a vector, and then the random access signal is converted from the frequency-domain to time-domain by Inverse Fast Fourier Transform (IFFT for short) processing, and then a modular squaring is calculated, a formula for calculating the modular squaring is represented as |Zᵢ|², wherein Zᵢ is is a time-domain random signal, and finally a peak detection sequence is obtained. Noise average estimation is performed on the peak detection sequence, and a signal detection threshold is obtained according to the estimation, the signal detection threshold is obtained by amplifying the result of noise average estimation for a certain multiple, and the specific multiple may be determined with empirical values or a result of simulation, and then a signal in a search window corresponding to the current frequency-domain cyclic shift sequence (i.e., the frequency-domain local cyclic shift sequence for estimating the weight in step 102) is detected, and a signal exceeding the threshold is selected. The signal exceeding the signal detection threshold is a valid signal, i.e. there is user sending the RACH signal; otherwise, the signal is considered as an invalid signal, i.e. there is no user sending the RACH signal.

Step 102˜step 103 are repeated, until all cyclic shift sequences of all root sequences are completely processed.

From the foregoing description, it will be seen that the method provided in the embodiment of the present document can overcome the deficiencies, including that known interference signal is required, and a plurality of reconstructions are required, and calculation is large. The method realizes the functions, including that the method cancels the deterioration of the miss detection performance and false alarm performance caused by the interference while the random access signal is detected, improves the accuracy of detection, and saves resources.

In the embodiment 2, when the random access signal is a random access signal of the repetition format, the following method is implemented, and as shown in FIG. 2, the method includes the following steps:

Step 201 is the same as step 101;

Step 202 is the same as step 102;

In step 203, power combination and peak detection are performed on the frequency-domain random access signal on which interference cancelling has been performed.

Wherein, the specific procedure of power combination and peak detection may include: the frequency-domain random access signal on which interference cancelling has been performed is conjugation dot multiplied by the frequency-domain local root sequence or the frequency-domain cyclic shift sequence, and then the random access signal is converted from frequency-domain to time-domain by Inverse Fast Fourier Transform processing, and then a modular squaring is calculated, a peak detection sequence is obtained. The power combination is performed on the peak detection sequences corresponding to the two repetition parts, and then noise average estimation is performed on the peak detection sequence on which the power combination has been performed, and the signal detection threshold is obtained according to an estimated value, and then a signal in the search window corresponding to the current frequency-domain cyclic shift sequence is detected, and a signal exceeding the threshold is selected.

Wherein, the method for performing power combination may be equal-gain combination or maximal-ratio combination, etc.

Step 202˜step 203 are repeated, until all cyclic shift sequences of all root sequences are completely processed.

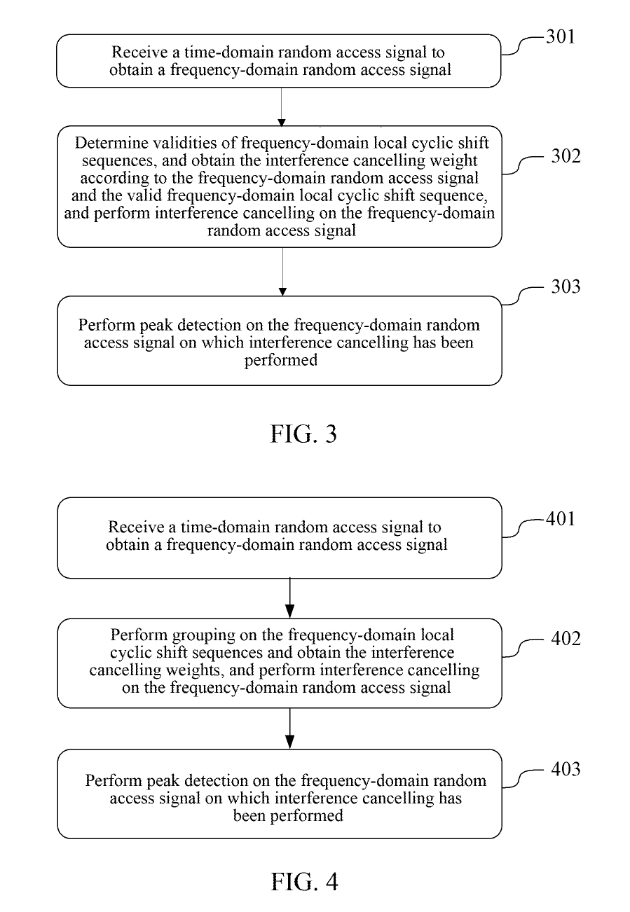

The embodiment 3 provides another method for detecting a random access signal in an interference environment, and as shown in FIG. 3, the method includes the following steps:

Step 301 is same as the step 101.

Step 302 is similar to the step 102, and the difference is that the sequence validities are determined for all the frequency-domain local cyclic shift sequences at first before the interference cancelling weights are obtained, the interference cancelling weight is obtained for the frequency-domain cyclic shift sequence which is determined to be valid, and then weighted combination is performed on the frequency-domain random access signal according to the interference cancelling weight, so as to obtain the frequency-domain random access signal on which interference cancelling has been performed.

Wherein, the specific procedure for determining the sequence validities may include: the validities are determined according to the characteristics of all the frequency-domain cyclic shift sequences R_{SY}, or all the frequency-domain cyclic shift sequences are grouped, and validity of each group is determined respectively.

Wherein, the characteristics of R_{SY} may include: a modular squaring of the sum, sum of the modular squaring, module of the sum, sum of the module, squaring of the sum of the real part, module of the sum of the real part, sum of the squaring of the real part, and sum of the module of the real part, etc, of R_{SY}.

Taking the modular squaring of the sum of R_{SY} as an example, the method for determining the sequence validity may include: when the ratio of some modular squaring of the sum of frequency-domain cyclic shift sequence R_{SY} to an average of an modular squaring of the sum of all the frequency-domain cyclic shift sequences R_{SY} is greater than a certain threshold, the cyclic shift sequence is considered as valid, otherwise, the cyclic shift sequence is considered as invalid. The threshold herein can be set according to the experience by a tester.

Taking the modular squaring of the sum of R_{SY} as an example, the method for determining the sequence validity may also include: when the ratio of a modular squaring of the sum of a frequency-domain cyclic shift sequence R_{SY} to an average of an modular squaring of the sum of all the frequency-domain cyclic shift sequences R_{SY} is greater than a certain threshold, and a ratio of a modular squaring of the sum of the frequency-domain cyclic shift sequence R_{SY} to a maximum of modular squarings of the sum of all the frequency-domain cyclic shift sequences R_{SY} is less than another certain threshold, the cyclic shift sequence is considered as valid, otherwise, the cyclic shift sequence is considered as invalid.

Of course, the method for determining the sequence validity may also be another method.

Step 303 is similar to step 103, herein the current frequency-domain cyclic shift sequence herein is the frequency-domain cyclic shift sequence which is determined to be valid in step 302.

The procedure after the validity determination of step 302˜step 303 is repeated, until all the frequency-domain cyclic shift sequences determined to be valid are completely processed.

The embodiment 4 of the present document provides another method for detecting a random access signal in an interference environment, and as shown in FIG. 4, the method includes the following steps:

Step 401 is the same as step 101.

Step 402 is similar to step 102, and the difference is that the group selection is performed on all the frequency-domain local cyclic shift sequences before obtaining the interference cancelling weights, and obtains the interference cancelling weight on the frequency-domain cyclic shift sequence on which group selection is performed, then group combination is performed on the interference cancelling weights which belong to the same group, and then weighted combination is performed on the frequency-domain random access signal according to the interference cancelling weight after group combination, thus the frequency-domain random access signal on which interference cancelling has been performed is obtained.

Wherein, the specific procedure of group selection may include: all the frequency-domain cyclic shift sequences are grouped at regular intervals, such as the interval is 2, 3 etc.; or grouped at irregular intervals, such as all the cyclic shift sequences of a root sequence are grouped into group 1, group 2, etc. All or part of the cyclic shift sequences in each group are selected to obtain the interference cancelling weights.

One cyclic shift sequence in each group is selected to obtain the interference cancelling weight.

Wherein, the specific procedure for group combination may include: the interference cancelling weights belonging to the same group are summed.

Step 403 is similar to step 103, and the difference is that peak detection is only performed on the frequency-domain cyclic shift sequences belonging to the same group when the peak detection is performed each time.

The procedure after the group selection in step 402˜step 403 is repeated, until all the frequency-domain cyclic shift sequences after the group selection are completely processed.

From the foregoing description, it will be seen that, according to the method provided in the embodiment of the present document, the interference cancelling is performed on the frequency-domain random access signal according to the characteristic of the random access signal itself and the relationship between the frequency-domain random access signal and the frequency-domain local cyclic shift sequence, to achieve the purpose of improving the miss detection performance and the false alarm performance. Meanwhile, the miss detection performance of the small signal may further be improved when there are small signal and large signal concurrently, so that the performance of the system is further improved. Additionally, because the method provided in the embodiments of the present document doesn't need the characteristic of the interference signal at the adjacent cell, or doesn't need to reconstruct the interference signal in the adjacent cell or the interference signal in the local cell, but implements interference cancelling directly, therefore the calculation is small, resources are saved, and the implementation of the system is beneficial to be realized.

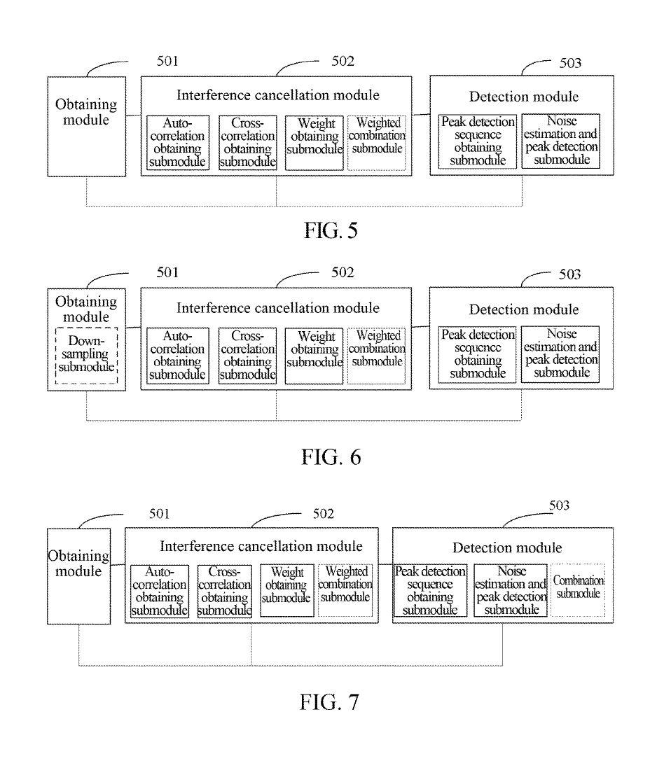

Correspondingly, the embodiment of the present document also provides a device for detecting a random access signal in an interference environment, and a structure of the device, as shown in FIG. 5, specifically includes:
an obtaining module 501, which is used to receive a time-domain random access signal to obtain a frequency-domain random access signal;
an interference cancellation module 502, which is used to obtain interference cancelling weights according to the frequency-domain random access signal and a frequency-domain local cyclic shift sequence, and perform interference cancelling on the frequency-domain random access signal; and
a detection module 503, which is used to perform peak detection on the frequency-domain random access signal on which interference cancelling has been performed.

Preferably, the interference cancellation module 502 may further include:
an auto-correlation obtaining submodule, which is used to obtain a result of an auto-correlation covariance matrix of the frequency-domain random access signal;
a cross-correlation obtaining submodule, which is used to obtain a result of a cross-correlation covariance matrix of the frequency-domain random access signal and frequency-domain local cyclic shift sequence;
a weight obtaining submodule, which is used to obtain the interference cancelling weight according to an output result of the auto-correlation obtaining submodule and an output result of the cross-correlation obtaining submodule;
a weighted combination submodule, which is used to perform weighted combination on the frequency-domain random access signal according to an output result of the weight obtaining submodule, to obtain the frequency-domain random access signal on which interference cancelling has been performed.

Preferably, the detection module 503 may further include:
a peak detection sequence obtaining submodule, which is used to conjugation dot multiply the frequency-domain random access signal on which interference cancelling has been performed by the frequency-domain local root sequence or the frequency-domain cyclic shift sequence, and then convert the RACH signal from the frequency-domain to time-domain by IFFT processing, and then calculate a modular squaring, and obtain a peak detection sequence;
a noise estimation and peak detection submodule, which is used to perform noise average estimation on the peak detection sequence, and obtain a signal detection threshold according to an estimated noise, and then detect a signal in a search window corresponding to a current frequency-domain cyclic shift sequence, and select a signal exceeding the threshold.

Preferably, as shown in FIG. 6, the obtaining module 501 may further include a down-sampling submodule, which is used to perform down-sampling on the received time-domain random access signal.

Preferably, as shown in FIG. 7, the detection module 503 may further include a combination submodule, which is used to perform power combination on the peak detection sequences corresponding to the two repetition parts, and then transmit the peak detection sequence on which the power combination has been performed to the noise estimation and peak detection submodule.

Preferably, as shown in FIG. 8, the interference cancellation module 502 may further include:
a sequence validity determination submodule, which is used to determine validities of all frequency-domain cyclic shift sequences first before the interference cancelling weights are obtained; at this moment, the current frequency-domain cyclic shift sequence when the detection module 503 performs the detection is a frequency-domain cyclic shift sequence determined to be valid by the module 502.

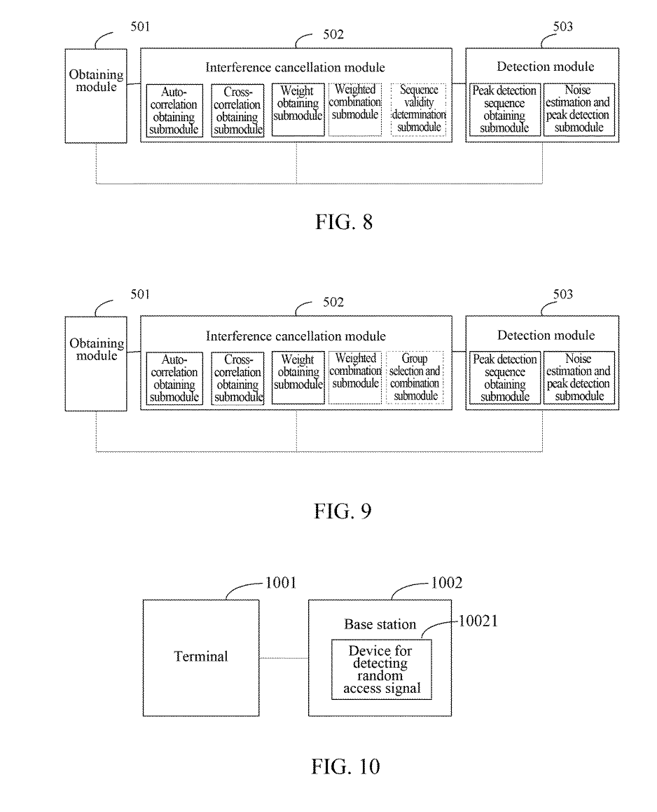

Preferably, as shown in FIG. 9, the interference cancellation module 502 may further include:
group selection and combination submodule, which is used to perform the group selection on all the frequency-domain cyclic shift sequences, and perform group combination on the interference cancelling weights which belong to the same group. At this moment, the current cyclic shift sequence when the detection module 503 performs the detection is a frequency-domain cyclic shift sequence belonging to the same group in the module 502.

From the foregoing description, it will be seen that, the device provided by the embodiments of the present document obtains the interference cancelling weights according to the frequency-domain random access signal and the frequency-domain local cyclic shift sequence, and performs weighted combination on the frequency-domain random access signal to achieve the purpose of cancelling the interference to improve the miss detection performance and the false alarm performance of the random access signal. Meanwhile, the miss detection performance of the small signal may also be improved when there are small signal and large signal concurrently, so that the performance of the system is further improved. Additionally, because the method provided by the embodiments of the present document doesn't need the characteristic of the interference signal at the adjacent cell, and doesn't need to reconstruct the interference signal at the adjacent cell or the interference signal at the local cell, but implements interference cancelling directly, therefore the calculation is small, resources are saved, and implementation of the system is beneficial to be realized.

Correspondingly, the embodiment of the present document further provides a system for detecting a random access signal in an interference environment, and as shown in FIG. 10, the system includes terminal 1001 and base station 1002, and the terminal 1001 is used to send a random access signal to the base station 1002, and the base station 1002 includes a device 10021 for detecting a random access signal in an interference environment; wherein the device is used to receive a time-domain random access signal to obtain a frequency-domain random access signal; and according to the frequency-domain random access signal and a frequency-domain local cyclic shift sequence, perform interference cancelling on the frequency-domain random access signal; and perform peak detection on the frequency-domain random access signal on which interference cancelling has been performed;
preferably, the device 10021 for detecting a random access signal in an interference environment includes:
an obtaining module, which is used to receive a time-domain random access signal to obtain a frequency-domain random access signal;
an interference cancellation module, which is used to perform interference cancelling on the frequency-domain random access signal according to the frequency-domain random access signal and a frequency-domain local cyclic shift sequence; and
a detection module, which is used to perform peak detection on the frequency-domain random access signal on which interference cancelling has been performed.

From the foregoing description, it will be seen that the method and device provided in the embodiments of the present document obtain interference cancelling weights according to the relationship of frequency-domain random access signal and the frequency-domain local cyclic shift sequence, and then perform weighted combination on the frequency-domain random access signal according to the interference cancelling weights, and thus the frequency-domain random access signal on which interference cancelling has been performed is obtained, to achieve the purpose of cancelling interference to improve the miss detection performance and the false alarm performance. Meanwhile, the miss detection performance of the small signal may also be improved when there are small signal and large signal concurrently, so that the performance of the system further is improved. Additionally, because the method provided by the embodiments of the present document doesn't need the characteristic of the interference signal at the adjacent cell, and doesn't need to reconstruct the interference signal at the adjacent cell or the interference signal at the local cell, but implements interference cancelling directly, and therefore the calculation is small, resources are saved, which are beneficial to the implementation of the system.

With the specific description of the implementations, the technical measures used by the present document to achieve the predetermined purposes and the technical effects should be more thoroughly and specifically understood. However, the illustrated accompanying drawings are only used for providing references and description, instead of limiting the present document. Additionally, in the case of no conflict, embodiments and features in the embodiments may be combined with each other.

The one skilled in the art should understand that, the embodiments of the present document can be provided as a method or computer program products. Therefore, a form of hardware embodiment, a form of software embodiment or a form of embodiment combining software aspect and hardware aspect can be used in the present document. Moreover, a form of a computer program product executed on one or a plurality of computer available memory mediums (including but not limited to a disk memory and an optical memory and so on) which contain computer available program codes.

The present document is described with reference to the flow charts and/or block diagrams of the method and computer program product according to the embodiments of the present document. It should be understood that each flow and/or block in the flow charts and/or block diagrams and a combination of flow and/or block in the flow charts and/or block diagrams can be implemented by computer program instructions. These computer program instructions can be provided to a general-purpose computer, a special-purpose computer, an embedded processing machine or processors of other programmable data processing devices to produce a machine, which makes the instructions executed by the computer or processors of other programmable data processing devices produce a device used for implementing functions specified in one or multiple flows of the flow charts and/or in one or multiple blocks of the block diagrams.

These computer program instructions also can be stored in a computer readable memory which can guide the computer or other programmable data processing devices to work in a specific way, which makes the instructions stored in the computer readable memory produce a manufacture including an instruction device, and the instruction device implements functions specified in one or multiple flows of the flow charts and/or in one or multiple blocks of the block diagrams.

These computer program instructions also can be loaded on the computer or other programmable data processing devices, which makes a series of operation steps be executed on the computer or other programmable devices to produce the processing implemented by the computer, thus, the instructions executed by the computer or other programmable devices provide the steps used for implementing functions specified in one or multiple flows of the flow charts and/or in one or multiple blocks of the block diagrams.

The above description is only the preferred embodiments of the present document, and is not intended to limit the protection scope of the present document.

### INDUSTRIAL APPLICABILITY

The method, device and system disclosed in the embodiments of the present document may cancel the deterioration of the miss detection performance and false alarm performance caused by the interference while the random access signal is detected, improve the accuracy of detection, and save resources.

What is claimed is:

1. A method for detecting a random access signal in an interference environment, comprising:
receiving a time-domain random access signal to obtain a frequency-domain random access signal;
obtaining interference cancelling weights respectively according to the frequency-domain random access signal and a frequency-domain local cyclic shift sequence, and performing interference cancelling on the frequency-domain random access signal with the obtained interference cancelling weights; and
performing peak detection on the frequency-domain random access signal on which interference cancelling has been performed.

2. The method according to claim 1, wherein, said receiving a time-domain random access signal to obtain a frequency-domain random access signal comprises performing down-sampling on the received time-domain random access signal firstly, and then performing Fast Fourier Transform to obtain the frequency-domain random access signal.

3. The method according to claim 1, wherein, said obtaining interference cancelling weights respectively according to the frequency-domain random access signal and a frequency-domain local cyclic shift sequence is calculated according to W=R_{SY}R_{YY}⁻¹, wherein, W represents an interference cancelling weight, R_{SY}=E{SY^{H}}, R_{YY}=E{YY^{H}}, S represents a frequency-domain local cyclic sequence, Y represents a frequency-domain random access signal before interference cancelling is performed, a number of dimensions of S is 1×N, a number of dimensions of Y is M×N, M represents a number of receiving antennas; and N represents a number of sub-carrier waves.

4. The method according to claim 1, wherein, said performing interference cancelling on the frequency-domain random access signal is calculated according to Ŷ=WY, wherein, W represents an interference cancelling weight, Ŷ represents a frequency-domain random access signal on which interference cancelling has been performed, and a number of dimensions of Ŷ is 1×N.

5. The method according to claim 1, wherein, the step of performing peak detection on the frequency-domain random access signal on which interference cancelling has been performed comprises:
conjugation dot multiplying the frequency-domain random access signal on which interference cancelling has been performed by a frequency-domain local root sequence or the frequency-domain cyclic shift sequence;
converting the signal obtained by conjugation dot multiplying from the frequency-domain to the time-domain;
calculating a modular squaring of the time-domain signal to obtain a peak detection sequence; and
detecting the peak detection sequence.

6. The method according to claim 5, wherein, said detecting the peak detection sequence comprises performing noise average estimation on the peak detection sequence, and obtaining a signal detection threshold according to an estimated value, then detecting a signal in a search window corresponding to a current frequency-domain cyclic shift sequence, and selecting a signal exceeding the threshold.

7. The method according to claim 5, wherein, said detecting the peak detection sequence comprises performing firstly power combination on the peak detection sequence of a random access signal with a repetition format, then performing noise average estimation on the peak detection sequence on which the power combination has been performed, and obtaining a signal detection threshold according to an estimated value, then detecting a signal in a search window corresponding to a current frequency-domain cyclic shift sequence, and selecting a signal exceeding the detection threshold.

8. The method according to claim 7, wherein, the power combination is equal-gain combination or maximal-ratio combination.

9. The method according to claim 1, wherein, before said obtaining interference cancelling weights according to the frequency-domain random access signal and a frequency-domain local cyclic shift sequence, the method further comprises determining sequence validities of all frequency-domain cyclic shift sequences.

10. The method according to claim 9, wherein, while determining sequence validities of all frequency-domain cyclic shift sequences before obtaining interference cancelling weights, when performing peak detection on the frequency-domain random access signal on which interference cancelling has been performed, only a search window corresponding to the frequency-domain cyclic shift sequence which is determined to be valid is detected.

11. The method according to claim 1, wherein, said obtaining interference cancelling weights respectively according to the frequency-domain random access signal and a frequency-domain local cyclic shift sequence, and performing interference cancelling on the frequency-domain random access signal further comprises performing group selection on all the frequency-domain cyclic shift sequences before obtaining the interference cancelling weights, and performing group combination on interference cancelling weights which belong to a same group after obtaining interference cancelling weights.

12. The method according to claim 11, wherein, the group selection is grouped at a regular interval or at an irregular interval.

13. The method according to claim 12, wherein, when group selection is performed on all the frequency-domain local cyclic shift sequences before obtaining the interference cancelling weights, said performing interference cancelling on the frequency-domain random access signal is that all or part of the cyclic shift sequences in each group are selected to obtain the interference cancelling weights, while said performing the peak detection on the frequency-domain random access signal on which interference cancelling has been performed is that peak detection is performed on a signal in a search window corresponding to frequency-domain cyclic shift sequences which belong to a same group.

14. A device for detecting a random access signal in an interference environment, comprising:
an obtaining module configured to receive a time-domain random access signal to obtain a frequency-domain random access signal;
an interference cancellation module configured to obtain interference cancelling weights according to the frequency-domain random access signal and a frequency-domain local circular shift sequence, and perform interference cancelling on the frequency-domain random access signal; and
a detection module configured to perform peak detection on the frequency-domain random access signal on which interference cancelling has been performed.

15. The device according to claim 14, wherein, the obtaining module comprises a down-sampling submodule, and the down-sampling submodule is configured to perform down-sampling on the received time-domain random access signal.

16. The device according to claim 14, wherein, the interference cancellation module comprises:
an auto-correlation obtaining submodule configured to obtain a result of an auto-correlation covariance matrix of the frequency-domain random access signal;
a cross-correlation obtaining submodule configured to obtain a result of a cross-correlation covariance matrix of the frequency-domain random access signal and the frequency-domain local cyclic shift sequence;
a weight obtaining submodule configured to obtain the interference cancelling weights according to an output result of the auto-correlation obtaining submodule and an output result of the cross-correlation obtaining submodule; and
a weighted combination submodule configured to perform weighted combination on the frequency-domain random access signal according to an output result of the weight obtaining submodule, to obtain the frequency-domain random access signal on which interference cancelling has been performed.

17. The device according to claim 14, wherein, the detection module comprises:
a peak detection sequence obtaining submodule configured to conjugation dot multiply the frequency-domain random access signal on which interference cancelling has been performed by the frequency-domain local root sequence or the frequency-domain cyclic shift sequence, and then convert the random access signal from the frequency-domain to time-domain by Inverse Fast Fourier Transform, and then calculate a modular squaring, and obtain a peak detection sequence; and
a noise estimation and peak detection submodule configured to perform noise average estimation on the peak detection sequence, and obtain a signal detection threshold according to an estimated noise, and then detect a signal in a search window corresponding to a current frequency-domain cyclic shift sequence, and select a signal exceeding the detection threshold, and
wherein, the detection module further includes a combination submodule, and the combination submodule is configured to, when the random access signal is a random access signal with a repetition format, perform power combination on the peak detection sequence corresponding to two repetition parts, and transmit the peak detection sequence on which the power combination has been performed to the noise estimation and peak detection submodule.

18. (canceled)

19. The device according to claim 16, wherein, the interference cancellation module further comprises a validity determination module, and the validity determination module is configured to determine sequence validities of all frequency-domain local cyclic shift sequences before obtaining the interference cancelling weights,
and,
wherein, the noise estimation and peak detection submodule is configured to, when the interference cancellation module determines the sequence validities of all the frequency-domain cyclic shift sequences before obtaining the interference cancelling weights, detect only a signal in the search window corresponding to the frequency-domain cyclic shift sequence which is determined to be valid.

20. (canceled)

21. The device according to claim 16, wherein, the interference cancellation module further comprises a group selection and combination submodule, and the group selection and combination submodule is configured to perform group selection on all the frequency-domain cyclic shift sequences, and to perform group combination on the interference cancelling weights which belong to a same group,
and,
wherein, the noise estimation and peak detection submodule is configured to, when the interference cancellation module groups all the frequency-domain cyclic shift sequences before obtaining the interference cancelling weights, perform peak detection only on a signal in a search window corresponding to frequency-domain cyclic shift sequences which belong to a same group.

22. (canceled)

23. A system for detecting a random access signal in an interference environment, comprises a terminal and a device for detection, wherein,
the terminal is configured to transmit a random access signal to a base station; and
the device for detection is configured to receive a time-domain random access signal to obtain a frequency-domain random access signal; and then according to the frequency-domain random access signal and a frequency-domain local cyclic shift sequence, perform interference cancelling on the frequency-domain random access signal; and perform peak detection on the frequency-domain random access signal on which interference cancelling has been performed.
